(19) United States
(12) Patent Application Publication
(10) Pub. No.: US 2012/0141338 A1
(43) Pub. Date: Jun. 7, 2012

(54) SAMPLE CAPTURE ELEMENT FOR SAMPLING DEVICE

(75) Inventors: Peter Alfred Blacklin, Columbia, MD (US); Wayne Fowler, JR., Annapolis, MD (US); Iasson Georgios Mustakis, East Lyme, CT (US); Joel Michael Hawkins, Old Lyme, CT (US)

(73) Assignee: METTLER-TOLEDO AG, Greifensee (CH)

(21) Appl. No.: 12/958,508

(22) Filed: Dec. 2, 2010

(51) Int. Cl. B01L 3/00

(52) U.S. Cl. 422/521

(57) ABSTRACT

An extendable sample capture element for use in a sampling device designed to extract samples, such as reaction/reactant samples, from vessels such as reactor vessels. A sample capture element of the present invention includes one or more concave sample pockets that may be of various shape and volume. A sample capture pocket is adapted to capture a known volume of material when the sample capture element is extended into said material. The material sample remains trapped in the sample capture pocket upon sample capture element retraction. When multiple pockets are present, at least one pocket may function as a mixing pocket. Ports in the sample pocket(s) may be placed in communication with corresponding material transfer channels extending through or along the sample capture element to allow for quenching, dilution and discharge of a captured material sample, such as discharge to an analyzer or another downstream location.

### TECHNICAL FIELD

The present invention is directed to a sampling device for acquiring a material sample. More particularly, the present invention is directed to an extendable sample capture element for use in a sampling device designed to extract samples such as, without limitation, reaction/reactant samples, from vessels such as reactor vessels.

### BACKGROUND

As would be obvious to one of skill in the art, there are a number of situations and/or processes for which it would be desirable to extract a sample of a material from a vessel in which the material is contained. Such extraction would generally be desirable for purposes of examination or testing, but could be performed for other reasons, as well.

With respect to process monitoring, such sample extraction may be desirable in a number of processes, including without limitation, parallel synthesis (combinatorial chemistry) applications, organic synthesis, chemical process development, and the scale-up of laboratory processes into production. A number of other such applications wherein sample extraction would be of interest also exist and would be known to those of skill in the art.

Known sampling devices typically must be operated by hand, or require the use of a vacuum-based device mounted remotely or in a vessel containing a material of interest, or a by-pass port or similar mechanism through which amount of a material of interest can be siphoned. In either case, an extracted sample is generally removed from the vessel and then transferred to another container before the sample can be quenched or similarly operated upon.

Known hand-operated devices commonly suffer from a lack of precision with regard to the timing of sample capture and subsequent sample manipulation and, obviously, are typically not amenable to process automation. Further, known hand-operated devices can only be operated to take samples that are at atmospheric pressure. Reactions that take place under pressure cannot be sampled with such hand operated devices. A by-pass type of sampling device, where the reaction flows through a loop to a point where it can be sampled, can be used to sample reactions under pressure—however, a large reaction volume is required to use such a device.

Known automated devices do not permit quenching, dilution, etc., to take place substantially contemporaneously with sample capture but, rather, require that a sample be first transferred to another vessel. Consequently, the state of a given sample may actually change from the time of sample extraction to the time of quenching, etc.

Therefore, based on these foregoing issues with known sampling devices, it should be apparent that an in situ sampling device capable of accurately and repeatably capturing a material sample of known volume and of quenching or otherwise processing a sample substantially contemporaneously with sample capture have been developed. These devices and their methods of use are described in U.S. patent application Ser. Nos. 12/823,655 and 12/823,718, both filed on Jun. 25, 2010.

Embodiments of sampling devices as described in these aforementioned applications may be disposed as elongate probes having extendable sample capture elements. Among other things, a sampling device of the present invention may be used to capture small sample volumes (e.g., 5-100 μl), and to extract a sample from within a reaction volume. Because such a sampling device is a sealed unit, it can also be placed through a port into a pressurized or evacuated reaction chamber to sample a pressurized reaction volume. Such a sampling device may also be used throughout a wide temperature range (e.g., −40° C.-150° C.).

In one exemplary embodiment of such a sampling device, the device is configured as a substantially cylindrical and hollow outer tube of some length. A proximal end of the outer tube may be clamped or otherwise affixed to a body portion of a probe actuator assembly. Concentrically arranged within the outer tube at a distal end thereof is an assembly including an outer sleeve, an inner sleeve and an extendable sample capture element. A substantially frustoconical adapter is attached to the distal end of the outer tube and tapers to a reduced diameter that approximates the diameter of the outer sleeve.

A sample capture element is located to reciprocate within the inner sleeve. The outer diameter of the sample capture element is provided to be close in dimension to the inner diameter of the inner sleeve, such that a tight but slidable fit is produced therebetween. When the sample capture element is in a retracted (closed) position, the distal end thereof may be positioned substantially even with the distal ends of the inner porting sleeve and the outer sleeve. When the sample capture element is in an extended (sampling) position, the distal end thereof may protrude from the distal end of the outer sleeve. The sample capture element is provided with at least one sample capture pocket that, during sample capture element extension, is exposed to and captures an amount of a sample of interest.

The sample capture element is ported to allow for purging/venting and to allow for the in situ processing (mixing, dilution, quenching, etc.), of material samples while located in the sample capture pocket(s) thereof. Particularly, each sample capture pocket is provided with a supply port and a purge/vent port, each of which is associated with a corresponding channel that runs through the sample capture element and exits through the proximal end thereof. Sample lines (e.g., tubing) may be connected to each of these supply and purge/vent channels to lead processing materials to the sample capture pocket and to allow for venting and for material to be purged from the sample capture pocket.

In another exemplary embodiment, the above-described design may be altered to have a fewer number of individual components. Particularly, in this alternative embodiment, the inner and outer sleeves and the adapter of the previously described embodiment are combined into a single element. This element forms an end cap that threads into the distal end of an outer tube and acts as a reciprocation guide and protective cover for the sample capture element. The end cap contains interior channels or grooves that connect the ports of the sample capture pocket of the sample capture element to the channels of the sample capture element.

During use of either of these embodiments, the distal end of the device is typically immersed in or held near the surface of a material from which a sample is to be extracted. At the desired time, the sample capture element is extended into the material, whereby an amount of the material fills the sample capture pocket(s) and remains therein as the sample capture element is subsequently retracted back into the closed position. With the sample of material trapped in the sample capture pocket(s), the sample may be processed, such as by contacting the sample with a quenching or diluting substance so as to halt an ongoing reaction or dilute the sample, prior to transferring the sample of material to another device or vessel.

Sample capture elements of the present invention may be used with such sampling devices to facilitate capture and processing of material samples of interest.

### SUMMARY OF THE GENERAL INVENTIVE CONCEPT

The present invention is directed to sample capture elements for use in sampling devices like those described in U.S. patent application Ser. Nos. 12/823,655 and 12/823,718. Such sample capture elements may typically be cylindrical in shape, although other cross-sectional shapes are also possible. The length of a sample capture element may vary depending on the length of other components of the sampling device.

In any event, a sample capture element of the present invention is designed to reciprocate within a body portion of an above-described sampling device. To that end, the outer surface (e.g., diameter) of the sample capture element is preferably of a dimension that produces a sealing but guided slidable fit with the sampling element within which it reciprocates.

A sample capture element of the present invention is provided with at least one concave sample capture pocket that, during sample capture element extension, is exposed to and captures an amount of a sample in which the distal end of the sampling device is immersed. The sample capture pocket(s) may be provided in different sizes to capture different sample volumes (aliquots). Similarly, the sample capture pocket(s) may be of various shapes to produce desired quenching, mixing, dilution and/or discharge (purge) characteristics.

The sample capture element is ported to allow for purging/venting and to allow for quenching of material samples located in the sample capture pocket(s) thereof. Particularly, a sample capture pocket of a sample capture element of the present invention is provided with a supply port and a purge/vent port, each of which is associated with a corresponding channel that runs through, or along the exterior of, the sample capture element, and exits through or along a proximal end thereof. The portion of the sampling device body within which the sample capture element reciprocates is adapted to allow the ports in the sample capture pocket(s) to communicate with the corresponding channels in the sample capture element during a quenching, dilution or purge cycle.

A sample capture element of the present invention may also be provided with a by-pass groove that is placed in fluid communication with transfer ports of the channels in the sample capture element to permit circulation of a quench media while the sample capture element is in an extended position. This allows sampling lines and the channels in the sample capture element to be filled with recirculating quench media such that quench media is available to immediately flow into the sample capture pocket(s) and mix with a captured sample upon retraction of the sample capture element.

Certain embodiments of a sample capture element of the present invention may have more than one sample capture pocket. When multiple sample capture pockets are present, the pockets may be of the same volume or of different volumes. When multiple sample capture pockets are present, the pockets may also have different functions—for example, one pocket may be a sample capture pocket and another pocket may function as a mixing pocket.

The porting of a sample capture pocket may be provided at a particular location and/or at a particular angle to optimize the quenching, dilution, mixing and/or discharge of a material sample located therein. The size, location and path of the corresponding channels in the associated sample capture element may be similarly designed to optimize one or more of such operations. A sample capture element of the present invention may be constructed of a material described in U.S. patent application Ser. Nos. 12/823,655 and 12/823,718, or of another material understood by one of skill in the art to be acceptable for such a purpose.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1a shows a portion of one exemplary embodiment of a sample capture element of the present invention, wherein the sample capture element includes a sample capture pocket of semi-spherical shape;

FIG. 1b depicts the portion of the sample capture element of FIG. 1a in transparency, such that ports associated with the sample capture pocket and associated channels in the sample capture element are visible;

FIG. 2a shows a portion of another exemplary embodiment of a sample capture element of the present invention, wherein the sample capture element includes a sample capture pocket of substantially the same volume as the pocket shown in FIGS. 1a-1b, but wherein the pocket is of frustoconical shape;

FIG. 2b depicts the portion of the sample capture element of FIG. 2a in transparency, such that ports associated with the sample capture pocket and associated channels in the sample capture element are visible;

FIG. 3 is an enlarged, transparent overlay of the sample capture pockets of FIGS. 1a-1b and 2a-2b;

FIGS. 4a-4b are two 3-dimensional rendered views of exemplary paths that may be formed by ports and associated channels used to provide material to and remove material from a sample capture element sample capture pocket;

FIGS. 5a-5d show various views of the flow within a semi-spherical sample capture pocket with a front port of a particular angle and a rear port of a particular angle and slope, with the front port used as the inlet port;

FIGS. 6a-6d show various views of the of the flow within the semi-spherical sample capture pocket of FIGS. 5a-5d having the same front port and rear port angle and slope, but with the rear port used as the inlet port;

FIGS. 7a-7e show various views of the flow within another semi-spherical sample capture pocket with a front port of an angle different than that of the sample capture pocket of FIGS. 5a-5d and 6a-6d and a rear port of an angle and slope different than that of the sample capture pocket of FIGS. 5a-5d and 6a-6d, with the front port used as the inlet port;

FIGS. 8a-8d show various views of the flow within the semi-spherical sample capture pocket of FIGS. 7a-7e having the same front port and rear port angle and slope, but with the rear port used as the inlet port;

FIGS. 9a-9b are transparent views of a portion of an exemplary embodiment of a sample capture element of the present invention, wherein the sample capture element includes a pair of sample capture pockets of semi-spherical shape; and

FIG. 10 is a transparent view showing a portion of an alternate exemplary embodiment of a sample capture element of the present invention having a single sample capture pocket and a secondary mixing pocket, both of semi-spherical shape.

### DETAILED DESCRIPTION OF EXEMPLARY EMBODIMENT(S)

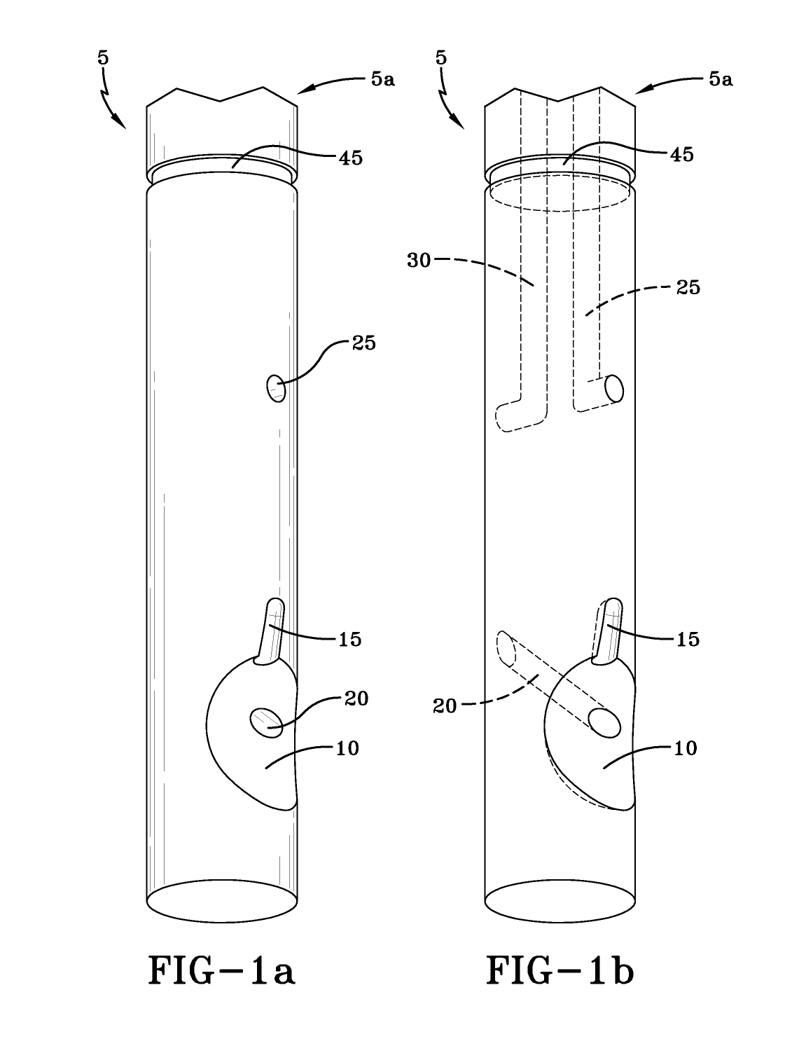

One exemplary embodiment of a sample capture element 5 of the present invention is illustrated in FIGS. 1a-1b. As mentioned above, the sample capture element 5 is located to reciprocate within a body portion of a sampling device, such as an inner sleeve. To that end, the outer diameter of the sample capture element 5 and the inner diameter of the surrounding element are of a dimension that produces a sealing but guided slidable fit therebetween.

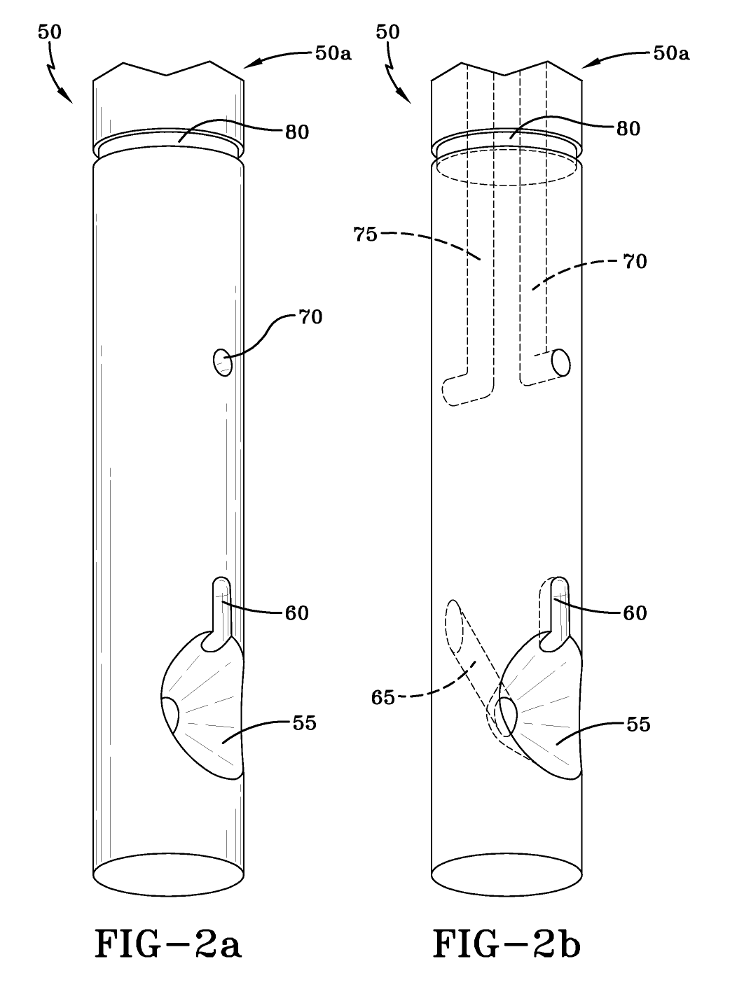

The sample capture element 5 is provided with a concave sample capture pocket 10 that, during sample capture element extension, is exposed to and captures an amount of a material in or over which the distal end of the associated sampling device is positioned. The sample capture pocket 10 may be provided in different sizes to capture different sample volumes (aliquots). In this particular embodiment, the sample capture pocket 10 is of semi-spherical shape. However, as demonstrated by FIGS. 2a-2b, a sample capture pocket may be of other shapes to produce desired quenching, mixing, dilution and/or discharge (purge) characteristics.

The sample capture element 5 is ported to allow for the quenching, dilution and discharge of material samples located in the sample capture pocket 10 thereof, and to allow for purging and venting. Particularly, the sample capture pocket 10 is provided with a first port 15 and a second port 20 for these purposes. The first port 15 may be an inlet port for supplying dilution, quench and purging materials to the sample capture pocket 10, and the second port 20 may be an outlet port for the discharge of a material sample and for purging and other materials supplied to the sample capture pocket. The role of the first port 15 and the second port 20 may also be reversed. As explained in more detail below, the angle (e.g., swirl angle) and axial slope of the ports 15, 20 may vary.

Each of the first port 15 and second port 20 is associated with a corresponding channel 25, 30 that extends along the sample capture element 5 and exits along the proximal end 5a thereof. In this particular embodiment, the channels 25, 30 run through the sample capture element 5. In other embodiments, such channels may be cut into the exterior of a sample capture element.

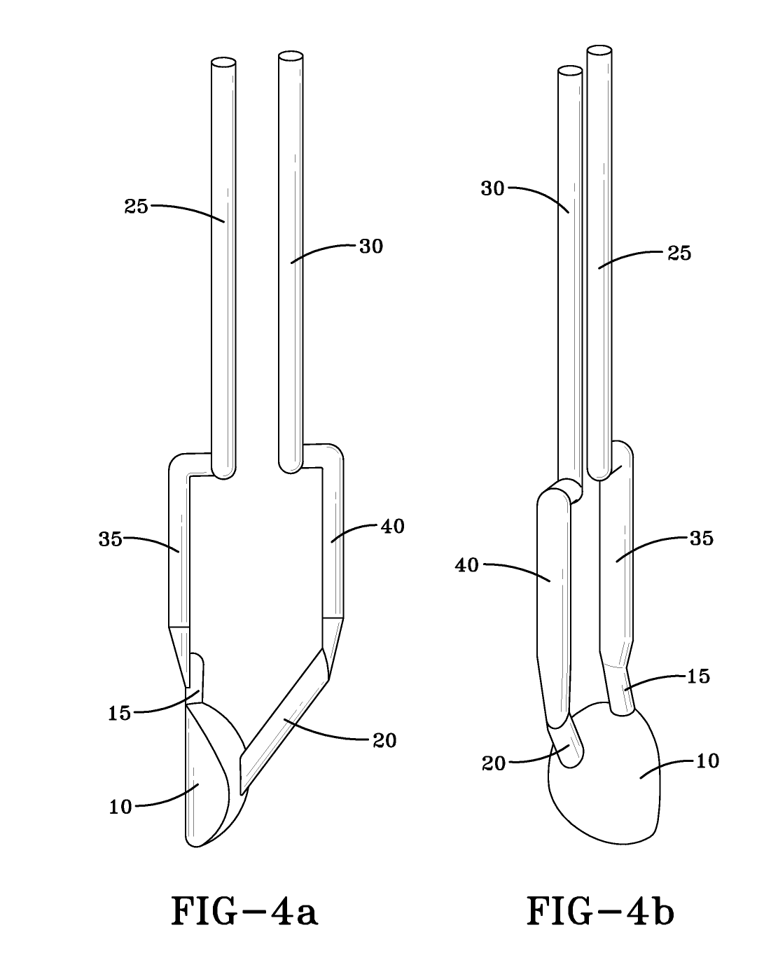

As represented in FIGS. 4a-4b, the ports 15, 20 in the sample capture pocket 10 are connected to the channels 25, 30 in the sample capture element 5 (when the sample capture element is retracted) by porting slots 35, 40 located in a portion of the sampling device in which the sample capture element 5 reciprocates. The porting slots 35, 40 and ports 15, 20 allow the sample capture pocket 10 to communicate with the corresponding channels 25, 30 in the sample capture element 5 during a purging, quenching, dilution or discharge cycle.

The channels 25, 30 connect the sample capture pocket 10 to sampling lines (not shown), which may be tubing or similar conduit. One of the sampling lines may be connected to sources of quench, dilution and purging materials, while another sampling line may direct used purging material to a waste location or a discharged material sample to an analyzer or another downstream location.

The sample capture element 5 may also be provided with a by-pass groove 45 that is placed in fluid communication with the channels 25, 30 in the sample capture element by the porting slots 35, 40 in the sampling body to permit circulation of a quench media while the sample capture element is in an extended position. This allows sampling lines and the channels 25, 30 in the sample capture element 5 to be pre-filled with recirculating quench media. Consequently, quench media is available to immediately flow into the sample capture pocket 10 and mix with a captured sample upon retraction of the sample capture element.

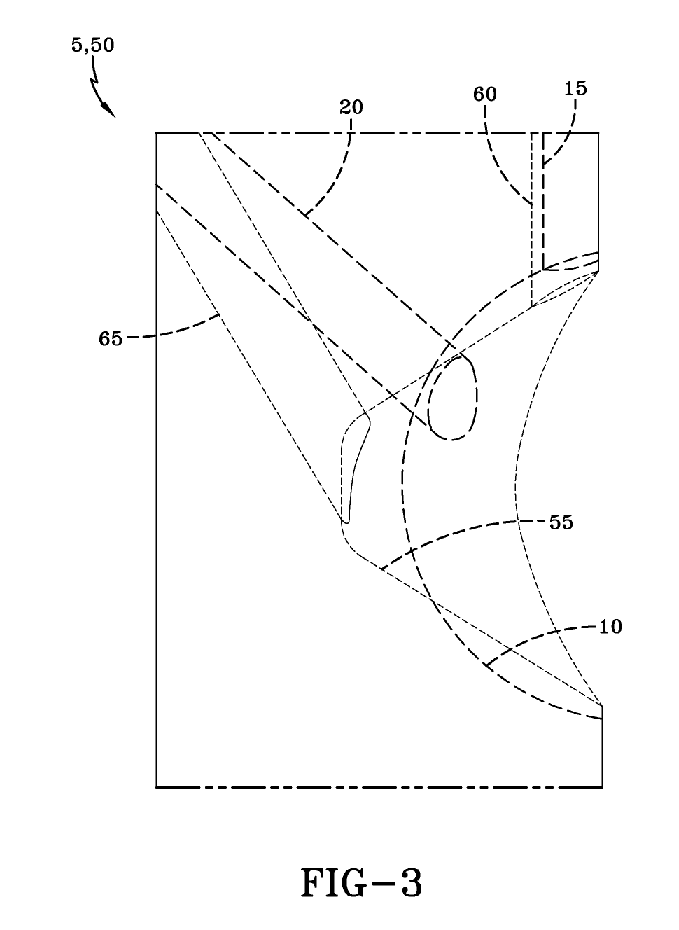

An alternate embodiment of a sample capture element 50 of the present invention is depicted in FIGS. 2a-2b. This sample capture element 50 is essentially the same as the sample capture element 5 shown in FIGS. 1a-1b, except that the sample capture pocket 55 of this alternate embodiment is of substantially frustoconical shape, as can also be observed in the pocket overlay of FIG. 3. Differences in sample capture pocket shape are discussed in more detail below.

The sample capture element 50 is also provided with ports 60, 65 for the purposes described above with respect to the embodiment of FIGS. 1a-1b. As previously explained, the first port 60 may be an inlet port for supplying dilution, quench and purging materials to the sample capture pocket 55, and the second port 65 may be an outlet port for the discharge of a material sample and for purging and other materials supplied to the sample capture pocket, or the role of the first port 60 and the second port 65 may be reversed. The angle (e.g., swirl angle) and axial slope of the ports 60, 65 may again vary.

As with the sample capture element 5 of FIGS. 1a-1b, each of the first port 60 and second port 65 is again associated with a corresponding channel 70, 75 that extends along the sample capture element 50 and exits along the proximal end 50a thereof. The ports 60, 65 in the sample capture pocket 55 are again connected to the channels 70, 75 in the sample capture element 50 (when the sample capture element is retracted) by porting slots 35, 40 located in a portion of the sampling device in which the sample capture element 50 reciprocates. This sample capture element 5 may also be provided with a by-pass groove 80 as described above with respect to the sample capture element 5 of FIGS. 1a-1b.

The length of a sample capture element of the present invention may vary depending on the length of other components of the sampling device to which the sample capture element is installed. Preferably, but not essentially, the length of the sample capture element is such that when the sample capture element is in a retracted (closed) position, the distal end thereof is positioned substantially evenly with a distal end of the sampling device body. When the sample capture element is in an extended (sampling) position, the distal end thereof protrudes from the distal end of the sampling device body by some predetermined distance. In any event, the proximal end of the sample capture element resides in the interior of the sampling device body, whether the sample capture element is in an extended or retracted position.

A sample capture element of the present invention may be constructed from various materials depending on the substances to which it might be exposed. For example, a sample capture element of the present invention may be constructed of a metallic material (e.g., HASTELLOY), a ceramic material or a glass material.

It has been determined that the optimal shape of the sample capture pocket of a given sample capture element may be influenced by a number of factors. These factors may include, without limitation: desired sample volume; proper sample capture; sealing with a surrounding sampling device element; load on the pocket area of the sample capture element during actuation; ease of pocket manufacture; the ability to achieve an acceptable surface finish during manufacturing; proper bubble (e.g., purge gas bubble) release upon sample capture element extension; port position for manufacturability; and port position for effective bidirectional flow.

As would likely be apparent to one of skill in the art, employing a sample capture pocket shape that facilitates manufacturing also generally improves the ability to achieve a good surface finish without the need for secondary operations. A simple sample capture pocket geometry may also be simpler to measure and verify.

As mentioned above, another consideration in designing a sample capture pocket is proper bubble release. Such a bubble will commonly form in the sample capture pocket when purging is accomplished with a gaseous purging material, the bubble being subsequently released from the sample capture pocket upon the next subsequent extension of the associated sample capture element. Typically, the gas bubble is released into a material of interest when the sample capture element is extended therein to acquire a material sample. In this regard, it has been discovered that gas bubble release is improved by employing a shallow sample capture pocket having shallow sides.

The position of the inlet and outlet ports of a sample capture pocket is ideally defined by optimizing the flow of liquid through the sample capture pocket during sample acquisition. Because the intended roles of the inlet and outlet ports of a given sample capture element may be reversed in use, the flow through the associated sample capture pocket should be effective in removing (discharging) a captured sample in either flow direction.

To this end, experimentation with various sample capture pocket shapes, port locations, and port angles has been conducted. Two sample capture pocket shapes that were tested include the semi-spherical and frustoconical pocket shapes shown in FIGS. 1a-1b and FIGS. 2a-2b, respectively.

The frustoconical pocket allowed for more extreme rear port positions to be tested and evaluated. It was determined from this testing that flow scavenging could be improved, as the conical shape appears to interfere with material flow through the sample capture pocket, thereby producing areas of low flow.

While of equal volume, the semi-spherical sample capture pocket of FIGS. 1a-1b is shallower than the frustoconical sample capture pocket of FIGS. 2a-2b. The semi-spherical shape was found to eliminate the low flow areas present in the frustoconical sample capture pocket.

During testing, it was determined that offsetting the front port created a strong scavenging swirl within the sample capture pocket when the front port was used as the inlet port. It was similarly determined that offsetting the rear port created a strong scavenging swirl within the sample capture pocket when the rear port was used as the inlet port. Further, it was found that the rear port entrance into the sample capture pocket needs to be below the lip of the sample capture pocket in order to avoid direct coupling. As used herein, “direct coupling” refers to a flow that does not produce a swirling effect within a sample capture pocket. More particularly, especially with respect to viscous material samples, it was determined that the inflow into a sample capture pocket could possibly punch a hole through the material and establish a direct flow between the inlet and outlet ports without producing a swirling of the material. The above-described location of the rear port entrance into the sample capture pocket helps to ensure that direct coupling does not occur.

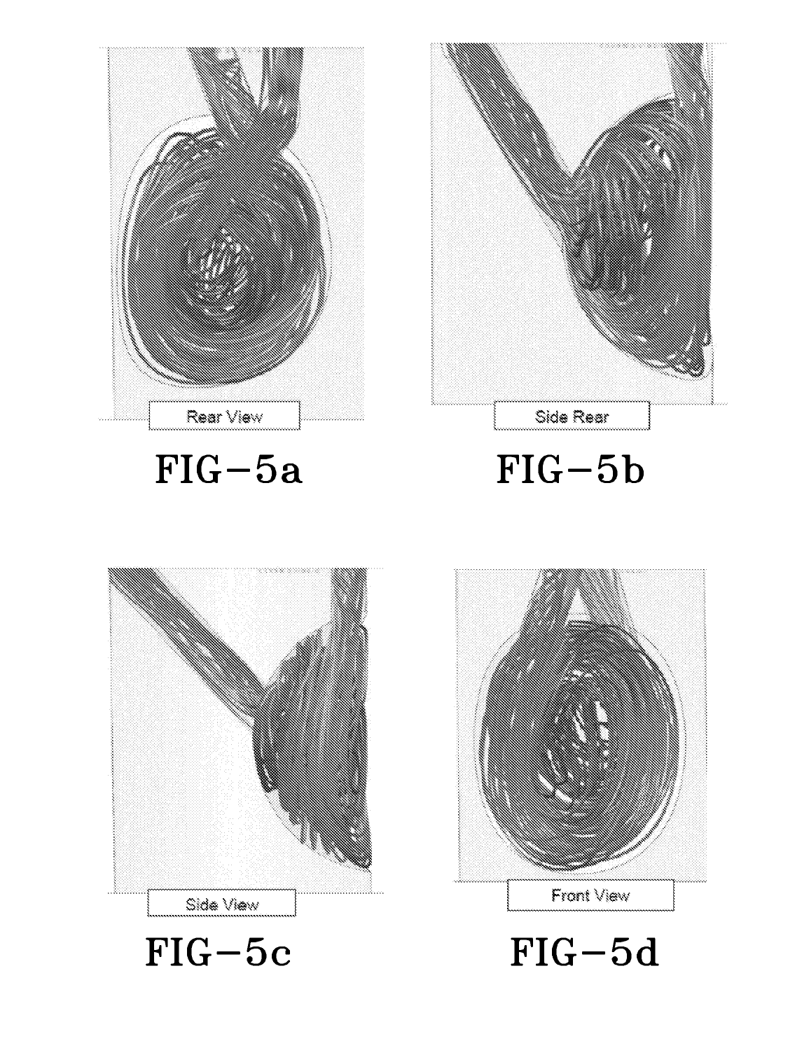

The aforementioned realizations were developed by running a number of different flow visualizations on various sample capture pocket and port designs. Several such exemplary flow visualizations produced using SOLIDWORKS FloXpress appear in FIGS. 5a-5d, 6a-6d, 7a-7e and 8a-8d. In each of these visualizations, the sample capture pocket is a portion of a 0.200 inch sphere with its center 0.110 inches from the centerline of the sample capture element, and the flowing material was selected as water. In each example, the front port is a groove cut into the surface of the sample capture element, and the rear port is bored through the sample capture element and into the sample capture pocket. Consequently, in each of the flow visualization examples shown herein, the front port is defined by its angular offset, while the rear port is defined by its angular offset and its slope relative to the centerline of the sample capture element.

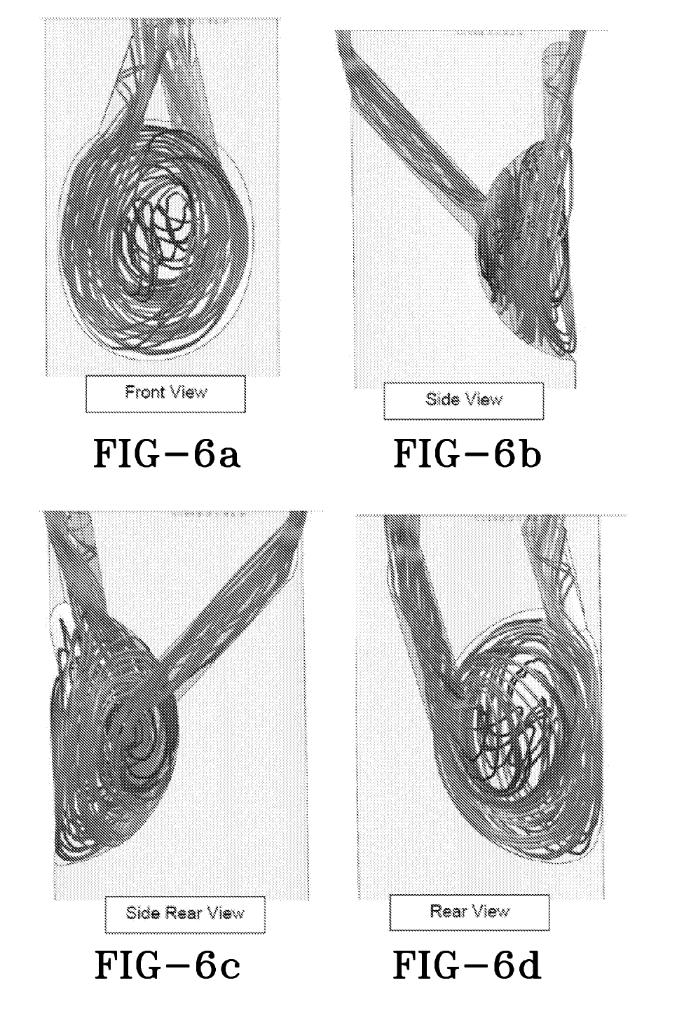

In the flow visualizations of FIGS. 5a-5d, the front port was used as the inlet port and the rear port as the discharge port. The front port and the rear port had a 20° swirl angle, and the rear port had a 43° axial slope. The flow visualizations of FIGS. 6a-6d are of the same sample capture pocket shown in FIGS. 5a-5d, but with the rear port used as the inlet port and the front port as the discharge port.

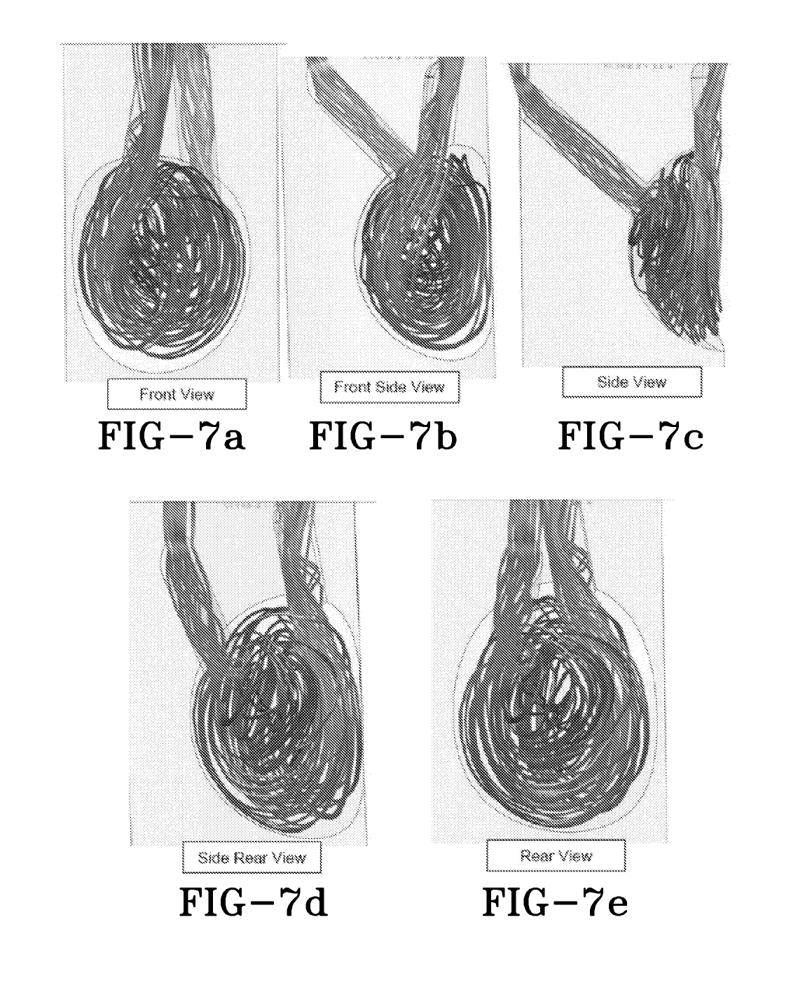

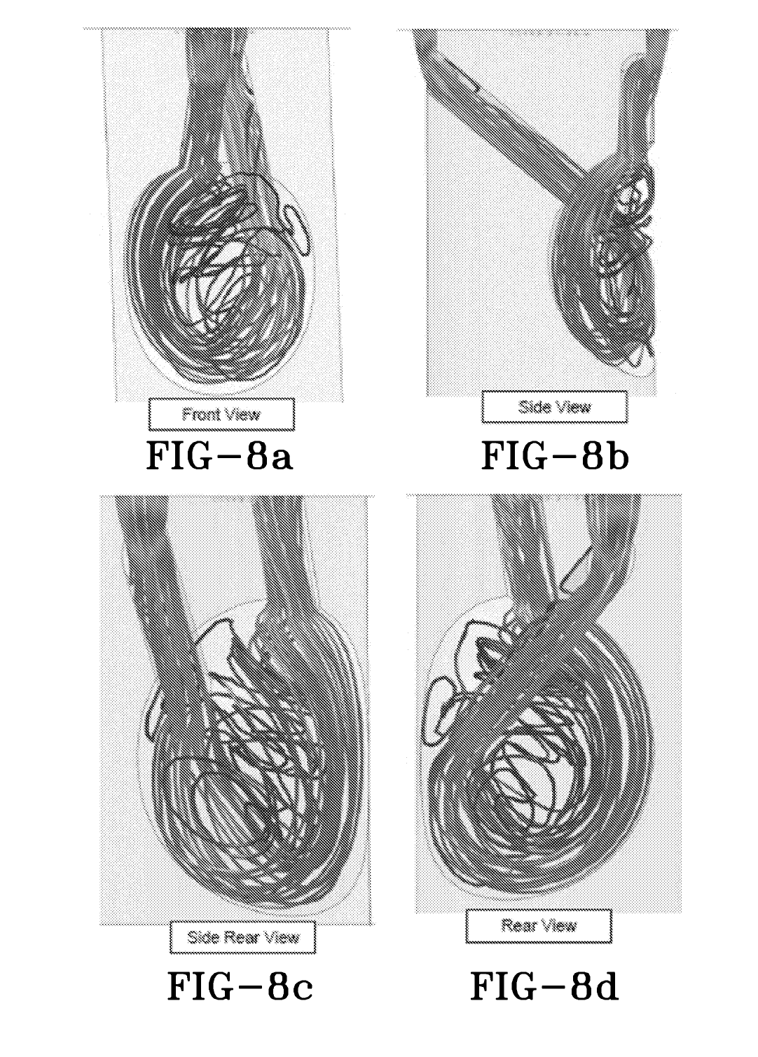

In the flow visualizations of FIGS. 7a-7e, the front port was used as the inlet port and the rear port as the discharge port. The front port had a 10° swirl angle, and the rear port had a 15° swirl angle and a 50° axial slope. The flow visualizations of FIGS. 8a-8d are of the same sample capture pocket shown in FIGS. 7a-7e, but with the rear port used as the inlet port and the front port as the discharge port.

When a sample capture element of the present invention is extended, the sample capture pocket thereof may be oriented in any direction with a material sample (e.g., reaction mixture). This allows the user to, for example, take advantage of the circulation of the material typically caused by stirring.

The fit of a sample capture element within its surrounding sleeve is such as to permit axial reciprocation of the sample capture element while simultaneously providing a seal capable of resisting internal pressures generated during, for example, quenching, purging and cleaning. The seal formed between the sample capture element and its surrounding sleeve should also be sufficient to prevent an intrusion of sample material caused by the external pressures that may exist within a sample reaction chamber or other vessel—whether the sample capture element is in an extended or retracted position.

The detailed design of the sample capture pocket lip minimizes or eliminates excessive wear of the sleeve that could be caused by repeated extension/retraction of the sample capture element. Additionally, upon retraction after sample capture, the sample capture element is wiped by the sleeve.

Several conclusions can be drawn from the conducted experimentation and the exemplary flow visualizations. These conclusions include, for example, that a spherical sample capture pocket improves the transfer of a captured sample and appears to produce a more desirable flow pattern in either direction. A spherical sample capture pocket also appears to produce a faster and more complete mixing and lower sample dilution values, and also allows the flow to be established around the largest dimension—the lip interface between the outer sealing sleeve and the sample capture element. The type of swirling flow produced within a spherical sample capture pocket is beneficial especially as the sample viscosity increases, as it releases the acquired sample from the walls of the sample capture pocket. The circular scavenging flow produced by such a sample capture pocket has also been found to be desirable particularly when the sample is a slurry, because maintaining the slurry in suspension allows for complete quenching and evacuation of the sample. The use of a spherical sample capture pocket has also been found to reduce tailing (i.e., the gradual reduction in sample concentration (from peak to zero) as the acquired sample is removed from the sample capture pocket).

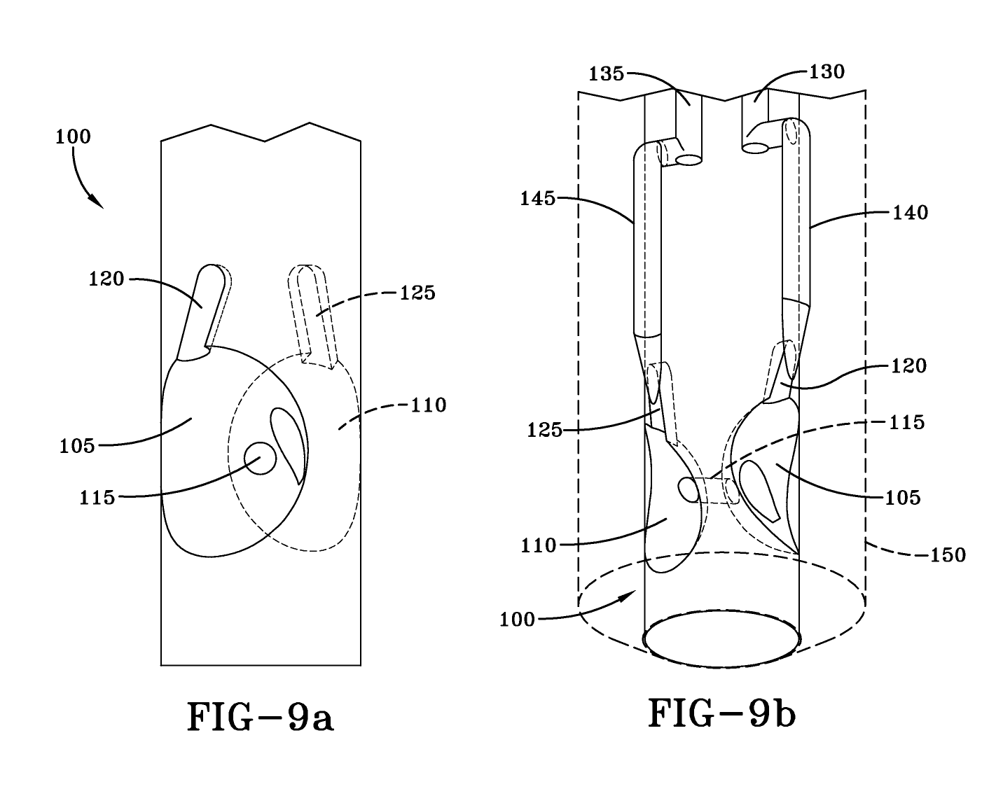

An alternate embodiment of a sample capture element 100 of the present invention is depicted in FIGS. 9a-9b. This sample capture element 100 is substantially similar to the sample capture elements shown in FIGS. 1a-1b and 2a-2b, except that two sample capture pockets 105, 110 are present. In this particular embodiment, the sample capture pockets 105, 110 are located diametrically opposite from one another and are substantially equidistant from the distal end of the sample capture element 100. The sample capture pockets 105, 110 are placed in fluid communication by a connecting port 115.

Each of the sample capture pockets 105, 110 includes a port 120, 125 for providing fluid communication between the sample capture pockets and channels 130, 135 in or on the sample capture element 100. As shown in FIG. 9b, the ports 120, 125 of the sample capture pockets 105, 110 are placed into communication with the channels 130, 135 of the sample capture element 100 by porting slots 140, 145 located in an element 150 of a sampling device in which the sample capture element reciprocates.

The two pocket design of this sample capture element 100 may allow a larger sample volume to be captured (in comparison to a sample capture element with a single sample capture pocket) while maintaining the same bubble release geometry and basic dimensions of a given sample capture element. Alternatively, such a two pocket design may provide for substantially the same sample capture volume as a single sample capture pocket, but may employ two shallower sample capture pockets to facilitate the capture of sample materials that tend to have difficulty flowing into a pocket.

The sample capture pockets 105, 110 may be of the same or of different dimensions and volumes. The connecting port 115 between the two sample capture pockets 105, 110 functions in a similar manner to the port 20 of FIGS. 1a and 1b, but this port provides for fluid communication between the two sample capture pockets.

In the embodiment of FIGS. 9a-9b, either of the ports 120, 125 may function as an inlet port for supplying a non-sample material (e.g., quench material) to the captured sample material. For example, if port 125 is selected as the inlet port during a quenching operation, a flow of quench material enters the associated sample capture pocket 110 and displaces some of the captured material residing therein through the connecting port 115 and into the other sample capture pocket 105. This will correspondingly cause some of the material from the receiving sample capture pocket 105, and possibly some of the captured material and/or quench material from the sending pocket 110, to be displaced into the porting slot 140 and possibly the channel 130.

The flow of quench material may then be reversed, such that sample and quench materials are drawn back through the sample capture pockets, which creates additional mixing. This cyclic flow pattern may be performed several times to achieve a fully quenched sample, which is then expelled through one of the porting slots and associated channels, and through a connected sample line to a downstream location (e.g., a sample vial, analysis system, etc.).

In the particular sample capture element 100 of FIGS. 9a-9b, the sample capture element 100 is substantially circular in cross-section and the sample capture pockets 105, 110 are located diametrically opposite from one another and are substantially equidistant from the distal end of the sample capture element 100. However, other sample capture pocket arrangements are also possible. In this regard, it is preferred, but not essential, that the lateral and vertical angles between the sample capture pockets of other sample capture element embodiments be configured to provide bi directional scavenging flow.

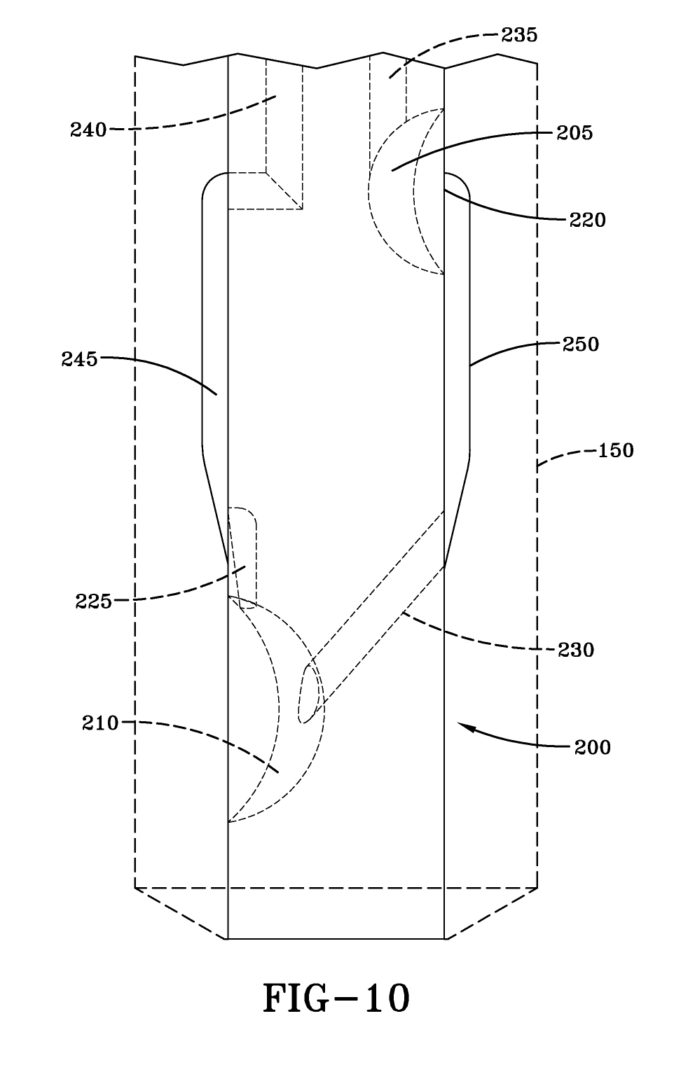

An alternative embodiment of a sample capture element 200 of the present invention is depicted in FIG. 10. In this exemplary embodiment, the sample capture element 200 is again substantially circular in cross-section and two pockets 205, 210 are again present. However, while the pockets 205, 210 of this embodiment may again (but not necessarily) be located substantially diametrically opposite from one another, they are not equidistant from the distal end of the sample capture element 200. Rather, an upper pocket 205 is shown to be farther from the distal end of the sample capture element 200 than a lower pocket 210.

The two pocket design of this sample capture element 200 allows the lower pocket to be used as a sample capture pocket 210 and the upper pocket to be used as a mixing pocket 205 within which a sample of material may be mixed with a quench medium, a dilution material, etc. Consequently, material samples will be trapped in the lower sample capture pocket 210, whereafter the material sample may be transferred in whole or part to the upper mixing pocket 205 for quenching or dilution prior to discharge to an analyzer or other downstream location.

To this end, the mixing pocket 205 includes an inlet port 220, while the sample capture pocket 210 includes an inlet port 225 for receiving non-sample materials and an outlet port 230 for providing fluid communication with the mixing pocket and between channels 235, 240 in or on the sample capture element 200. In this embodiment, an inlet port 225 of the sample capture pocket 210 connects the sample capture pocket to a corresponding sample capture element channel 240 via a porting slot 245 in the element 150 of the sampling device in which the sample capture element reciprocates. The outlet port 230 of the sample capture pocket 210 connects the sample capture pocket to the mixing pocket 205 via a second porting slot 250 and the mixing pocket inlet port 220 located in the surrounding element 150 of the sampling device. Particularly, the inlet port 220 of the mixing pocket 205 is connected to the second porting slot 250, and the mixing pocket is also connected to a corresponding channel 235 in the sample capture element 200.

As an example of a quenching operation involving such a sample capture element 150, the mixing pocket 205 may be supplied with quench media while the sample capture element 200 is extended to capture a material sample of interest in the sample capture pocket 210. After sample capture element retraction, quench material may be supplied to the sample capture pocket 210 via its inlet port 225. The flow of quench material into the sample capture pocket 210 quenches some of the sample located therein and displaces some of the sample through the outlet port 230 and into the mixing pocket 205, which is already charged with quench media. Thus, quenching mixing is now occurring at both ends of the acquired sample, which hastens the quenching process.

The flow of quench material may then be reversed, such that sample and quench materials are drawn back through the sample capture and mixing pockets, which creates additional mixing. As described above, this cyclic flow pattern may be performed several times to achieve a fully quenched sample, which is subsequently expelled from the mixing pocket 205, through the channel 235, and through a connected sample line to a downstream location (e.g., a sample vial, analysis system, etc.). Such a cyclic flow process may additionally assist in placing slurries into suspension.

As shown in FIG. 10, the sample capture pocket 210 and the mixing pocket 205 of this particular sample capture element have different volumes. Particularly, the sample capture pocket 210 is shown to have a larger volume than the mixing pocket 205. However, it is to be understood that the size relationship of the pockets of such an embodiment may be reversed. Further, the volume of the sample capture and mixing pockets may also be of substantially the same volume.

While certain embodiments of the present invention are described in detail above, the scope of the invention is not to be considered limited by such disclosure, and modifications are possible without departing from the spirit of the invention as evidenced by the following claims:

What is claimed is:

1. A sample capture element for use in a sampling device designed to capture a sample of a material of interest, said sample capture element comprising:
an elongate body having a proximal end for direct or indirect connection to an actuator, and a distal end for extension from a body portion of a sampling device to which said sample capture element is installed;
a sample capture pocket located near said distal end of said sample capture element, said sample capture pocket adapted to capture a volume of material;
an inlet port in said sample capture pocket for supplying material thereto, said inlet port oriented at an angle that causes a swirling of said material upon entry thereof into said sample capture pocket; and
an outlet port in said sample capture pocket for expelling material therefrom.

2. The sample capture element of claim 1, wherein an outer surface thereof is of a dimension that produces a sealing but slidable fit with a mating surface of a sampling device element within which said sample capture element reciprocates.

3. The sample capture element of claim 1, wherein said sample capture pocket is semi-spherical in shape.

4. The sample capture element of claim 1, wherein said sample capture pocket is frustoconical in shape.

5. The sample capture element of claim 1, wherein said inlet port and said outlet port are in fluid communication with corresponding channels in or on said sample capture element when said sample capture element is in a retracted position.

6. The sample capture element of claim 4, wherein said inlet and outlet ports are placed in fluid communication with said corresponding channels by associated porting slots that reside in a sampling device element within which said sample capture element reciprocates.

7. The sample capture element of claim 1, further comprising a by-pass groove that allows for the circulation of a fluid through a non-sample capture pocket portion of said sample capture element while said sample capture element is extended from an associated sampling device.

8. A sample capture element for use in a sampling device designed to capture a sample of a material of interest, said sample capture element comprising:
an elongate body having a proximal end for direct or indirect connection to an actuator, and a distal end for extension from a body portion of a sampling device to which said sample capture element is installed;
a pair of sample capture pockets located in said sample capture element, said sample capture pockets dimensioned to hold some volume of material;
an inlet port in each sample capture pocket for supplying material thereto, said inlet port oriented at an angle that causes a swirling of said material upon entry thereof into said sample capture pocket;
an outlet port in each sample capture pocket for expelling material therefrom to a channel on/in said elongate body; and
a connecting port extending between said sample capture pockets, said connecting port placing said pockets in fluid communication with one another.

9. The sample capture element of claim 8, wherein an outer surface thereof is of a dimension that produces a sealing but slidable fit with a mating surface of a sampling device element within which said sample capture element reciprocates.

10. The sample capture element of claim 8, wherein at least one of said sample capture pockets is semi-spherical in shape.

11. The sample capture element of claim 8, wherein at least one of said sample capture pockets is frustoconical in shape.

12. The sample capture element of claim 8, wherein the lateral and vertical angles between said sample capture pockets results in a bi-directional scavenging flow through said pockets.

13. The sample capture element of claim 8, wherein said elongate body is substantially circular in cross-section and said sample capture pockets are located substantially diametrically opposite to one another and substantially equidistant from a distal end of said sample capture element.

14. The sample capture element of claim 8, wherein said pair of sample pockets are located substantially diametrically opposite to one another and at different distances from a distal end of said sample capture element.

15. A sample capture element for use in a sampling device designed to capture a sample of a material of interest, said sample capture element comprising:
an elongate body having a proximal end for direct or indirect connection to an actuator, and a distal end for extension from a body portion of a sampling device to which said sample capture element is installed;
a sample capture pocket located in said sample capture element, near a distal end thereof, said sample capture pocket dimensioned to hold some volume of material;
a mixing pocket located in said sample capture element, said mixing pocket located further from said distal end of said sample capture element than is said sample capture pocket, said mixing pocket dimensioned to hold some volume of material;
an inlet port in said sample capture pocket for supplying non-sample material thereto;
an outlet port in said sample capture pocket, said outlet port connected to an inlet port of said mixing pocket;
an inlet port in said mixing pocket, said inlet port for supplying material from said sample capture pocket to said mixing pocket; and
an outlet port in said mixing pocket for expelling material therefrom to a channel on/in said elongate body.

16. The sample capture element of claim 15, wherein said sample capture pocket and said mixing pocket are of substantially the same volume.

17. The sample capture element of claim 15, wherein the volume of said sample capture pocket is greater than the volume of said mixing pocket.

18. The sample capture element of claim 15, wherein the volume of said mixing pocket is greater than the volume of said sample capture pocket.

19. The sample capture element of claim 15, wherein said inlet port of said sample capture pocket is oriented at an angle that causes a swirling of material upon entry thereof into said sample capture pocket.

20. The sample capture element of claim 15, wherein said elongate body is substantially circular in cross-section and said sample capture pocket is located substantially diametrically opposite from said mixing pocket.
